(19) United States
(12) Patent Application Publication
(10) Pub. No.: US 2006/0064385 A1
(43) Pub. Date: Mar. 23, 2006

(54) System for purchasing CNC program-use licenses over the internet, utilizing the CNC machine control

(76) Inventor: Kenneth J. Susnjara, Birdseye, IN (US)

Correspondence Address: LAU & ASSOCIATES, 7701 ROCKLEDGE COURT, SPRINGFIELD, VA, 22152, US

(21) Appl. No.: 10/920,321

(22) Filed: Aug. 18, 2004

(51) Int. Cl. G06Q 99/00

(52) U.S. Cl. 705/59

(57) ABSTRACT

An Internet is connected to both a host computer and a computer numerical controller that is controlling a CNC machine. Stored therein the controller is an encrypted program which requires a pre-paid license to decrypt the encrypted program first before execution of the program by the controller is made possible. When the number of pre-paid licenses are all used, the controller facilitates the purchase of a number of pre-paid licenses with the host computer via the Internet.

### BACKGROUND OF THE INVENTION

The field of furniture manufacturing encompasses an extensive range of manufacturing processes and business functions. A typical product begins with the basic process of design and development. Working-drawings, bills of material, and production processes are derived through the design and development processes. Raw manufacturing materials and components must be selected, ordered, and stocked for each specific product design. Appropriate machinery must be selected and configured to suit each required fabrication process.

The competitive nature of the manufacturing industry necessitates spreading these development and procurement costs over long production runs in order to recover costs while minimizing the price of the end-product. The traditional manufacturing model, which evolved throughout the past century, is therefore based on manufacturing specifically targeted products in large volumes over as long a time-period as the prevailing markets will allow. Unfortunately, this model severely limits the scope of many small, low-volume manufacturing operations. Many small furniture-manufacturing firms do not have the capacity or financial advantage to compete with large high-volume manufacturers; due to the cost of production, they have often been relegated to crafting expensive custom products with a very limited market share.

In recent years, prior art has addressed these problems through advancements in computer technology. It is possible, through the use of computer-aided design (CAD) and computer-aided manufacturing (CAM) software, to design furniture components, and simultaneously generate basic cut-path programs for fabricating said components on a computer numeric controlled (CNC) machine. Each basic structural component for the product can then be fabricated on a CNC machining center utilizing the aforementioned work-piece-cutting program. Consequently, products may be engineered, produced, and delivered to the end user within a relatively short period, utilizing only a few key personnel. Such advancements have greatly benefited the furniture industry, particularly the small manufacturing operation.

There are however, problems yet to be overcome by the smaller business operators who desire to compete in the same markets as the high volume manufacturers. One of the main obstacles is the time and skill required to produce complex CNC programs required for producing ornate woodwork components. Program-code for producing components may be generated through several different means including, a Computer-aided Design software system, the inputting of program codes through the controller keyboard, or by the inputting of codes through a hand-held teach-pendant.

The CNC machine is well adapted for executing cut-path programs, both on the x-y plane, and in 3-D model space. X-y planer programs, even those with complex curves, are relatively easy to produce, utilizing either an off-line computer-based software system or the CNC control itself. However, when components with complex three-dimensional curves and carved features must be produced, the level of complexity increases significantly. Some examples of such items are illustrated in FIG. 3, including a top 301, a structural top 302, a drawer front 304, a drawer separator 306, a leg assembly 308, a back panel 310, a top molding 312, a case side panel 314 and a base frame assembly 316. When any of these components are required, there are several options available, none of which is economically viable for the low-volume producer. Said options include, scanning a hand-carved component with a special following probe, thereby generating coded cut-path geometry for replicating the product on a CNC machine; carving the component by hand on a piece-by-piece basis; or, to a limited extent, generating the program by means of a specialized CAM system such as Mastercam. The aforementioned methods require expensive equipment, an inordinate amount of, time and technical expertise, and in some cases, extraordinary manual skills.

### SUMMARY OF THE INVENTION

The present invention serves to overcome the deficiencies of prior art by providing a means whereby programs for producing wood furniture components may be selected from a broad assortment provided by another party. An entitlement license providing for one or more uses of individual programs is purchased over the Internet, by credit card, utilizing the CNC machine control to facilitate the ordering process. Said programs are resident in the machine control in encrypted form, and may be utilized only for the number of work-piece processing cycles purchased. This allows the small, low-volume operator with a CNC machine to quickly develop a product and then, utilize programs to produce complex components for the product without the need for more complex programming operations. An object of the present invention is to provide the ability to produce high quality, ornate attributes for wood furniture, without the expenses normally associated with the development of such complex CNC programs.

A further object of the present invention is to streamline the CNC production process by negating the need for extensive programming time.

A still further object of the present invention is to license programs already embedded in the user's computer to avoid extensive, lengthy downloading.

Further objects of the present invention will become apparent from the detailed description that follows.

### BRIEF DESCRIPTION OF THE DRAWING

FIG. 1 illustrates the embodiment of a CNC machining center.

FIG. 2 is a flow chart depicting the sequential process of obtaining over the Internet, a license for the use of a work-piece-processing program.

FIG. 3 exemplifies some of the more complex components comprising an eighteenth-century style kneehole desk.

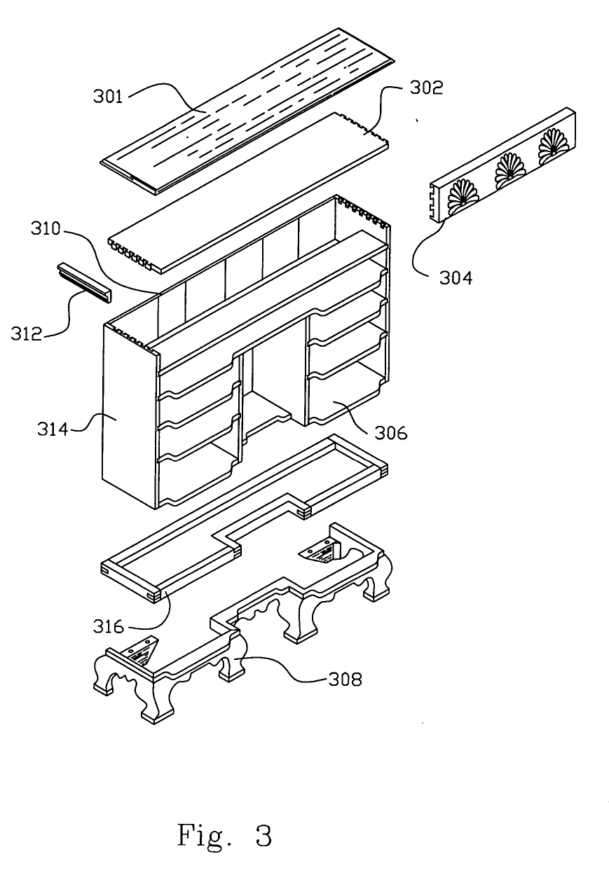

### DETAILED DESCRIPTION OF THE PREFERRED EMBODIMENTS

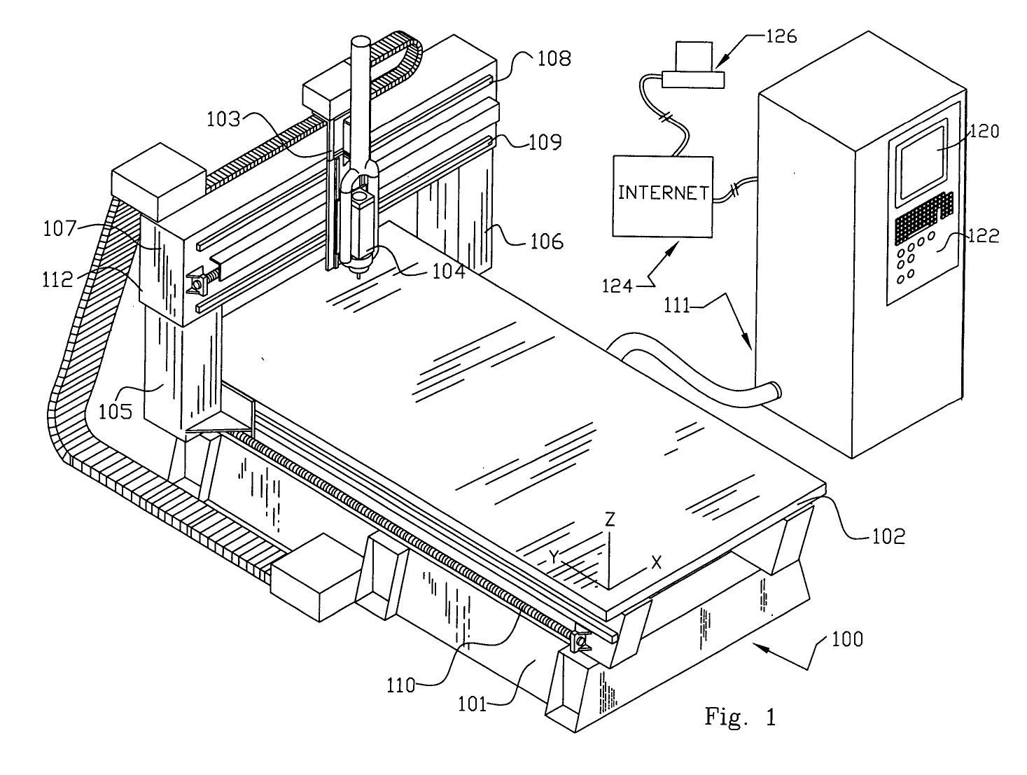

Referring to the drawing in FIG. 1, there is illustrated, an embodiment of a computer numeric controlled (CNC) machining system 100, which generally includes a base member 101, a worktable 102, a gantry 112, a tool-head support assembly 103, and an electric spindle, 104. The gantry 112, includes a pair of leg members, 105 and 106, rigidly secured at their lower ends to the base member and a transversely disposed section 107, supported on the leg sections and spanning above the worktable 102. Said gantry 112 is adapted to be displaced longitudinally relative to the base member along the y-axis. The base member is formed of steel sections welded together to provide a rigid and stable foundation. Worktable 102, is mounted horizontally with the surface parallel to the x-y axes plane. The front face of transverse section 107, is provided with a pair of vertically spaced, transversely disposed rails 108, and 109, on which tool-head support assembly 103, is mounted and displaceable transversely or along an x-axis. Electric spindle 104, is mounted on the bottom of the tool-head support assembly 103 and is adapted to be displaced vertically by same. Each of gantry 112, tool-head support assembly 103, and electric spindle 104, is displaceable along its respective axis by a feed-screw arrangement driven by an AC servomotor. The operation of said servomotors is controlled by a programmable computer-numeric controller (CNC) 111 to provide for movement of a tool mounted on the tool-head along a motion path to perform a work function such as routing, shaping, drilling and the like on a work-piece mounted on the worktable. Instead of the gantry being displaceable and the worktable being stationary as described, such as Thermwood model No. 53, the gantry can be stationary and the worktable may be displaceable along the Y-axis to provide displacement between the gantry and the worktable, such as Thermwood model No. 40. These Thermwood models are incorporated herein by reference.

In the present invention, the controller 111 includes a monitor 120 and an input device 122. The controller 111 is connected to a host computer 126 via an Internet 124.

The present invention embodies a software system and a method for purchasing over the Internet, entitlement licenses for the use of complex CNC computer programs. A set of work-piece processing programs, developed by a different party, is pre-loaded in a special directory in the CNC machine control. Said programs are encrypted, and may not be accessed or executed until decrypted by the transmission of a special code by the Licensor. A program may be called, and the operator may execute one complete cycle, only if a licensing fee for the use of said program has been paid. A purchaser may buy multiple licenses for running a program, but each time said program is executed, the entitlement decrements by one cycle.

The CNC operator selects a program from a list of available programs, displayed on the CNC control monitor 120. The computer checks the selected program file for a validation code, to verify that a valid license exists for the use of said program. If an entitlement license for use of the program is available, the program file is decrypted and rendered usable for the operator. The operator may then proceed through the process of executing the program for one complete cycle. If, however, there is no license available for the use of the program, the operator is given an option to purchase one or more licenses from the licensor. A prompt is displayed on the control display screen, inquiring as to whether or not the operator desires to purchase one or more licenses for the program. If the operator inputs information in the affirmative, another prompt asks for a password. The number of cycles to be licensed is entered, then the control automatically logs onto the Internet to a predetermined website. The host computer checks the purchaser's control to determine if the purchaser is registered. If the purchaser is registered, data, such as credit card billing information, is already available on the host computer. After verifying credit card validity with a credit card company, the host computer compiles all the pertinent information to be sent out to the credit card company for billing. A code is then transmitted to the purchaser's control, allowing the desired program to be decrypted for the number of cycles for which it has been licensed. The user then continues with the process of executing the program.

If however, the purchaser's control is not registered, the purchaser must enter data such as credit card information before the transaction can be finalized. After all required information is entered and the purchaser is registered, the aforementioned code is transmitted to the purchaser's control, allowing the desired program to be decrypted for use. It is possible to have one or more program-use entitlements available, based on the number of cycles licensed by the licensee.

At some points well into the run-cycle, the pre-paid entitlement license is decremented by one cycle. If some types of errors were to occur during the initial execution phase of the program, it is conceivable that the program would need to be aborted, resulting in the loss of the entitlement license without deriving any benefit from the purchase; said decrementing is thus delayed to ensure that the program is successfully initiated and placed into operation.

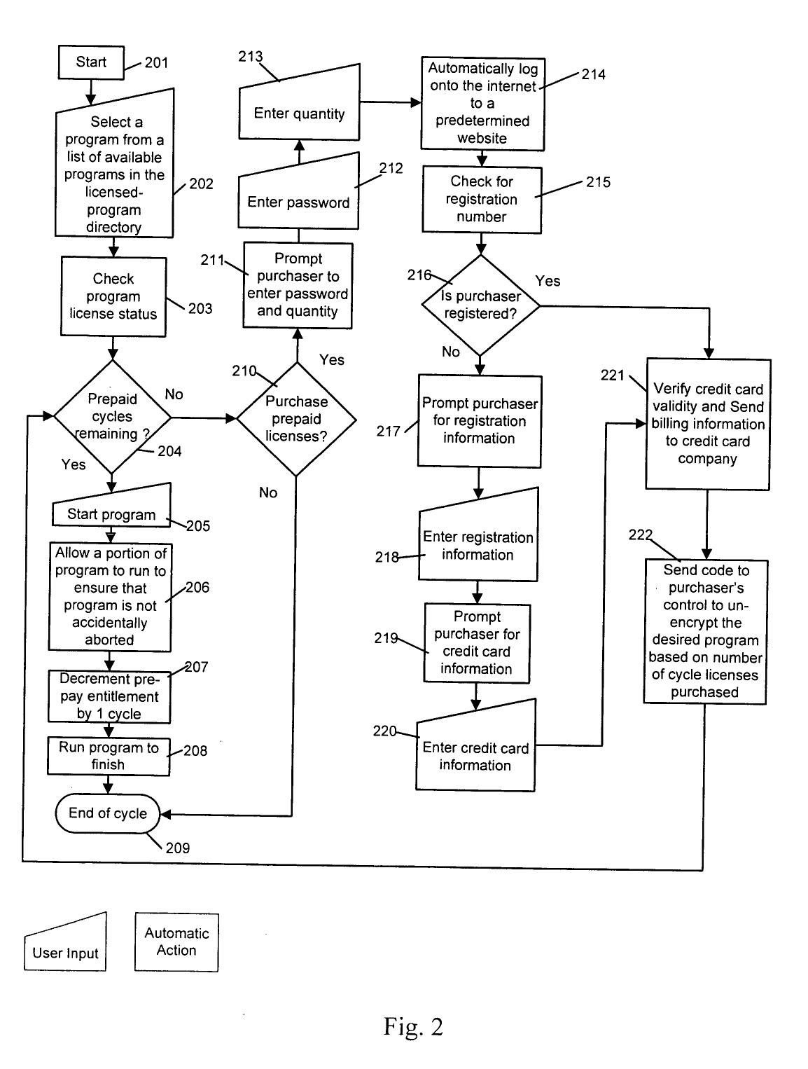

Referring to the flow chart in FIG. 2, the operator initiates the process of selecting a licensed program at step 201. A program is selected from a list of programs in the licensed program directory at step 202. The Computer then checks the licensing status of the selected program to ensure that a valid license exists for that program at step 203. If it is determined that prepaid licenses remain available at step 204, the control prompts the operator to initiate the start of the program at step 205.

If there are no prepaid licenses available for the desired program, the user is prompted as to whether or not a license is desired at step 210. If no license is desired, the process is ended at step 209. If the user wishes to purchases one or more licenses for the program, the control prompts for a password and quantity at step 211. The user then enters a password at step 212 and a quantity at step 213, and the control automatically logs onto the Internet to a predetermined website of a host computer at step 214. The host computer then checks for a registration code in the user's control at step 216. If the user is registered, the host computer verifies credit card validity with a credit card company at step 221 and sends a code to the user's controller at step 222, allowing the program to be decrypted at step 222. The controller then prompts the operator to initiate the start of the program at step 205.

If the user is not registered, the host computer prompts for registration information at step 217. The user then enters the required information at step 218, and the host computer prompts for credit card data at step 219. The user then enters required credit card data at step 220, after which the host computer verifies the validity of the user's credit card with a credit card company and transmits billing information to the credit card company at step 221. A code is then sent to the user's controller to decrypt the desired program, based on the number of cycles purchased. The program start cycle is then initiated at step 205.

In all of the above-described circumstances, after the program has been allowed to run for a predetermined period to ensure that no malfunctions have occurred in the initiation process at step 206, the prepaid entitlement is decremented by one cycle at step 207, The program is allowed to run to completion at step 208, and the cycle is ended at step 209.

From the foregoing detailed description, it is apparent that there are a number of changes, adaptations and modifications of the present invention which come within the province of those persons having ordinary skill in the art to which the aforementioned invention pertains. However, it is intended that all such variations not departing from the spirit of the invention be considered as within the scope thereof as limited solely by the appended claims.

I claim:

1. A method to obtain a license from a host computer via an Internet to decrypt an encrypted program pre-stored in a computer numerical controller, comprising a step of:
a. selecting the encrypted program pre-stored in the controller.

2. The method of claim 1, further comprising a step of:
b. checking a licensing status of the encrypted program.

3. The method of claim 2, further comprising a step of:
c. determining whether any pre-paid license remains for the encrypted program based on the licensing status.

4. The method of claim 3, further comprising a step of:
d. applying a code associated with a pre-paid license to decrypt the encrypted program and executing a predetermined portion of the decrypted program if any pre-paid license remains.

5. The method of claim 4, further comprising a step of:
e. continuing execution of the predetermined portion of the decrypted program.

6. The method of claim 5, further comprising a step of:
f. decrementing a count of any pre-paid licenses by one after completing execution of the predetermined portion of the decrypted program.

7. The method of claim 6, further comprising a step of:
g. continuing execution of the decrypted program until completion.

8. The method of claim 7, further comprising a step of:
h. prompting whether to purchase any license if no pre-paid license remains.

9. The method of claim 8, further comprising a step of:
i. ending operation if an input of not to purchase any license is received.

10. The method of claim 8, further comprising a step of:
j. prompting to enter a password associated with the computer numerical controller if an input to purchase a number of licenses is received.

11. The method of claim 10, further comprising a step of:
k. prompting to enter a number of licenses to be purchased.

12. The method of claim 11, further comprising a step of:
l. automatically establishing a communication between the controller and the host computer over the Internet.

13. The method of claim 12, further comprising a step of:
m. determining based on the password whether a registration number is pre-established with the host computer.

14. The method of claim 13, further comprising a step of:
n. verifying a credit card information associated with the registration number with a credit company if the registration number is pre-established.

15. The method of claim 14, further comprising a step of:
o. automatically making a bill presentment to the credit card company.

16. The method of claim 15, further comprising a step of:
p. downloading a number of licenses purchased and associated codes to the controller via the Internet, then go to step c.

17. The method of claim 13, further comprising a step of:
q. prompting to enter registration information to establish a registration number if a registration number is not pre-established with the host computer.

18. The method of claim 17, further comprising a step of:
r. collecting registration information.

19. The method of claim 18, further comprising a step of:
s. prompting to enter credit card information.

20. The method of claim 19, further comprising a step of:
t. collecting credit card information then go to step n.

21. A computer numerical controlled machining system, comprising:
a host computer with a web-site being connected to an Internet;
a computer numerical controller with a monitor, an input device and a storage device being connected to the Internet;
a machine with a worktable being supported by a base member, wherein the base member comprises a first pair of rails;
a gantry being moveably secured to the first pair of rails along a Y-axis; the gantry comprises a disposed transversely section located above a pair of leg members, wherein the disposed transversely section comprises a second pair of rails;
a support assembly being moveably secured to the second pair of rails along an X-axis, wherein the support assembly comprises a third pair of rails;
an electric spindle being moveably secured to the third pair of rails along a Z-axis;
wherein the electric spindle being displaceable along the X-axis, Y-axis and Z-axis.

22. The computer numerical controlled machining system of claim 21, wherein a pre-stored encrypted program being stored in the storage device of said controller.

23. The computer numerical controlled machining system of claim 21, wherein the electric spindle is stationary and the workstation is moveable along the X-axis, Y-axis and Z-axis.

24. The computer numerical controlled machining system of claim 22, wherein the monitor displays to an end-user a list of available programs.

25. The computer numerical controlled machining system of claim 24, wherein the input device received entry of selecting the pre-stored encrypted program from the list of available programs.

26. The computer numerical controlled machining system of claim 25, wherein the controller checks a program licensing status of the pre-stored encrypted program.

27. The computer numerical controlled machining system of claim 26, wherein the controller makes a determination as to whether any pre-paid license is available for the pre-stored encrypted program.

28. The computer numerical controlled machining system of claim 27, wherein the controller uses a code associated with a pre-paid license to decrypt the pre-stored encrypted program and starts execution of a predetermined portion of the decrypted program if it is determined that a pre-paid license is available.

29. The computer numerical controlled machining system of claim 28, wherein upon completing execution of the predetermined portion of the decrypted program, the controller decrements a count of any pre-paid licenses by one.

30. The computer numerical controlled machining system of claim 29, wherein the controller continued execution of the decrypted program until completion.

31. The computer numerical controlled machining system of claim 27, wherein the monitor prompts a decision whether to purchase any pre-paid license if the determination indicates no more pre-paid license is available.

32. The computer numerical controlled machining system of claim 31, wherein the controller ends operation if an input of not to purchase any license is received from the input device.

33. The computer numerical controlled machining system of claim 31, wherein the monitor prompts an entry of a password and a quantity of pre-paid licenses to be purchased.

34. The computer numerical controlled machining system of claim 33, wherein the controller automatically establishes a communication with the host computer via the Internet upon receiving entry of the password and the quantity of pre-paid licenses to be purchased.

35. The computer numerical controlled machining system of claim 34, wherein the host computer makes a determination as to whether a registration number associated with the controller is pre-established.

36. The computer numerical controlled machining system of claim 35, wherein the host computer makes a determination as to whether the end-user associated with the controller is a registered purchaser with credit card information pre-stored in the host computer.

37. The computer numerical controlled machining system of claim 36, wherein the host computer verifies credit card validity provided by the end-user with a credit card company and makes a bill presentment to the credit card company if the determination indicates that the end-user is a registered purchaser.

38. The computer numerical controlled machining system of claim 37, wherein a number of codes corresponding to the quantity of pre-paid licenses to be purchased is downloaded from the host computer to the controller via the Internet.

39. The computer numerical controlled machining system of claim 36, wherein the monitor prompts the end-user to provide registration information if the determination indicates that the end-user is not a registered purchaser.

40. The computer numerical controlled machining system of claim 39, wherein registration information is entered via the input device.

41. The computer numerical controlled machining system of claim 40, wherein the monitor prompts the end-user to provide credit card information.

42. The computer numerical controlled machining system of claim 41, wherein credit card information is entered via the input device.

43. The computer numerical controlled machining system of claim 42, wherein the host computer makes a verification as to the validity of the credit card information with a credit card company and makes a bill presentment to the credit card company.

44. The computer numerical controlled machining system of claim 43, wherein a number of codes corresponding to the quantity of pre-paid licenses to be purchased is downloaded from the host computer to the controller via the Internet.

45. A computer numerical controlled machining system, comprising:
a controller pre-stored with an encrypted program that can be decrypted by a license;
a host computer selling the license;
wherein the controller and the host computer are connected with each other via an Internet so that the license is downloaded from the host computer to the controller.
